(19) United States
(12) Patent Application Publication
(10) Pub. No.: US 2011/0296386 A1
(43) Pub. Date: Dec. 1, 2011

(54) Methods and Systems for Validating Changes Submitted to a Source Control System

(75) Inventors: Robert C. Woollen, San Rafael, CA (US); Scott Hansma, San Francisco, CA (US); Aaron Arruda, San Francisco, CA (US); Thomas Kim, San Francisco, CA (US)

(73) Assignee: salesforce.com, Inc., San Francisco, CA (US)

(21) Appl. No.: 13/034,656

(22) Filed: Feb. 24, 2011

Related U.S. Application Data
(60) Provisional application No. 61/396,556, filed on May 28, 2010.

(51) Int. Cl. G06F 9/44

(52) U.S. Cl. 717/124

(57) ABSTRACT

In accordance with embodiments, there are provided mechanisms and methods for validating changes before submission to a source control system, which can provide developers with a remote server where changelists may be uploaded, specified tests may be run, and results may be returned to the developer. The ability to provide a remote server for changelist uploads, automated source code compilations, automated test executions, and the automatic return of results, tends to enable developers to quickly and efficiently make source code design changes and avoid to build breakages.

### CLAIM OF PRIORITY

This application claims priority benefit of U.S. Provisional Patent Application 61/396,556 entitled METHODS AND SYSTEMS FOR VALIDATING CHANGES SUBMITTED TO A SOURCE CONTROL SYSTEM, by Yerkes et al., filed May 28, 2010 (Attorney Docket No. 48-31/349PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. patent application Ser. No. ______ entitled, METHODS AND SYSTEMS FOR VALIDATING CHANGES SUBMITTED TO A SOURCE CONTROL SYSTEM, by Yerkes et al., filed ______ (Attorney Docket No. 48-42/349US).

### FIELD OF THE INVENTION

The present invention relates generally to computer systems and more specifically to validating changes submitted to a source control system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user typically uses their own system to retrieve data from and store data on such a conventional database system. A user system might remotely access one of a plurality of server systems that might in turn access the database system. Data retrieval from the system might include the user system issuing a query to the database system. The database system might process the information request received in the query and send to the user information relevant to the request.

Conventional database systems use software applications to handle and process many different user requests. As database systems become more sophisticated, the software applications that run and maintain the databases may also become more complicated. Consequently, the development and testing of database software applications may become complex and inefficient.

In conventional software development, developers write source code to add new features, functionality, and address deficiencies of prior software versions. Developers also conceptualize test plans, create test cases to test the source code, and execute testing before deploying the new code. In some development methodologies, before a developer can deploy the new source code, the developer must submit, or check-in, the new source code on a shared development server to be compiled and tested.

Unfortunately, compiling and testing complicated source code may result in errors, or breakages. A breakage requires the software developer to debug the cause of the breakage and may also require other developers to wait for the source code to be repaired. It becomes particularly cumbersome when employing fast-paced Scrum development methodology, since the methodology encourages small iterative development life cycles and test driven development. Further, additional developers may need to assist in the debugging of the broken source code, which may lead to a further loss of productivity.

Accordingly, it is desirable to provide a method and system for validating new source code that increases efficiency by eliminating and/or reducing build breakages and simplifying the process of testing and deploying new code before submission to a source control system.

### BRIEF SUMMARY

In accordance with embodiments, there are provided mechanisms and methods for validating changes before submission to a source control system. These mechanisms and methods for validating changes before submission to a source control system can enable embodiments to provide developers with a remote server where changelists (or any list of changes of source code) may be uploaded, specified tests may be run, and results may be returned to the developer. In this specification names of objects are descriptive and indicate the purpose and/or method of functioning of the object. Similarly, in this specification names of variables and/or storage locations are descriptive and indicate the purpose and/or the nature of the content stored in the variable and/or storage location. The ability of embodiments to provide a remote server for changelist uploads, automated source code compilations, automated test executions, and the automatic return of results, tends to enable developers to quickly and efficiently make source code design changes and avoid build breakages.

In an embodiment and by way of example, a method for validating changes before submission to a source control system is provided. In an embodiment, a request to upload a changelist is received by a remote server. In response to the request, the remote server acknowledges the request, receives the changelist, automatically runs a build based on the changelist, automatically runs specified tests on the compiled code, and returns the results to the developer. In an embodiment, the developer will have the option to automatically submit the code changes based on the developer's credentials for successful runs.

While the present invention is described with reference to an embodiment in which techniques for validating changes before submission to a source control system may be implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2C® by IBM and the like, or without the benefit of any databases, without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an example of an environment wherein an on-demand database service might be used;

FIG. 2 illustrates a block diagram of an embodiment of elements of FIG. 1 and various possible interconnections between these elements;

FIG. 3 shows a flowchart of an example software development cycle;

FIG. 4 shows a flowchart of a software development cycle incorporating an example of source code validation before submission to a source control system;

FIG. 5 illustrates a block diagram of an example automated build environment;

FIG. 6 illustrates a block diagram of an example pre-check-in source code validation system;

FIG. 7 illustrates a block diagram of an embodiment of a developer workstation system with automated build environment components and pre-check-in validation components;

FIG. 8 illustrates a block diagram of an example of an environment wherein an on-demand database service and a pre-check-in source validation system might be used;

FIG. 9 shows an embodiment of a user side method for source code validation before submission to a source control system;

FIG. 10 shows an embodiment of a system side method for source code validation before submission to a source control system;

FIG. 11 shows an embodiment of a detailed system side method for source code validation before submission to a source control system;

FIG. 12 shows an example of a method of making the environment of FIGS. 1 and 2.

### DETAILED DESCRIPTION

### General Overview

Systems and methods are provided for validating changes submitted to a source control system. As used herein, the term multi-tenant database system refers to those systems in which various hardware and software elements may be shared by more than one customer. For example, a given application server may simultaneously process requests for a great number of customers, and a given database table may store rows for a potentially much greater number of customers. As used herein, the term query plan refers to a set of steps used to access information in a database system.

Next, mechanisms and methods for providing validation of changes submitted to a source control system will be described with reference to example embodiments.

### System Overview

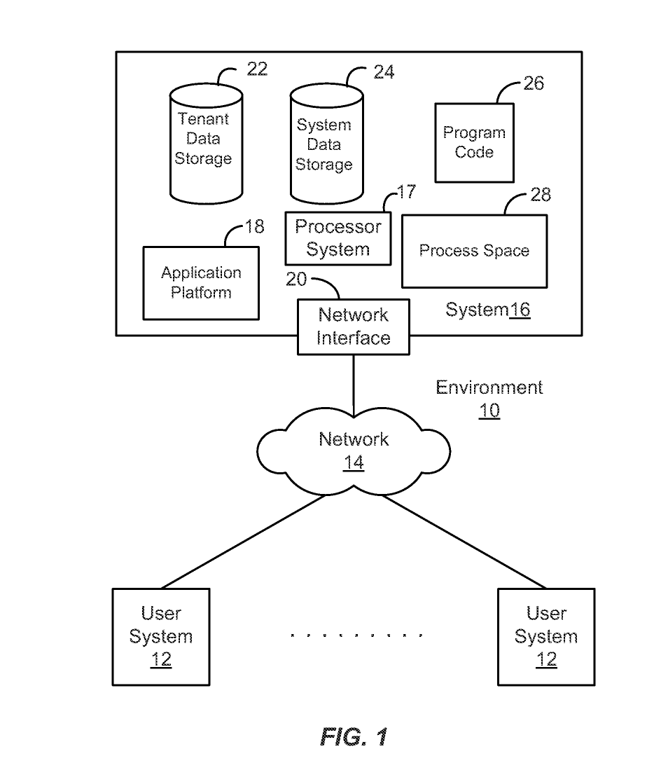

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

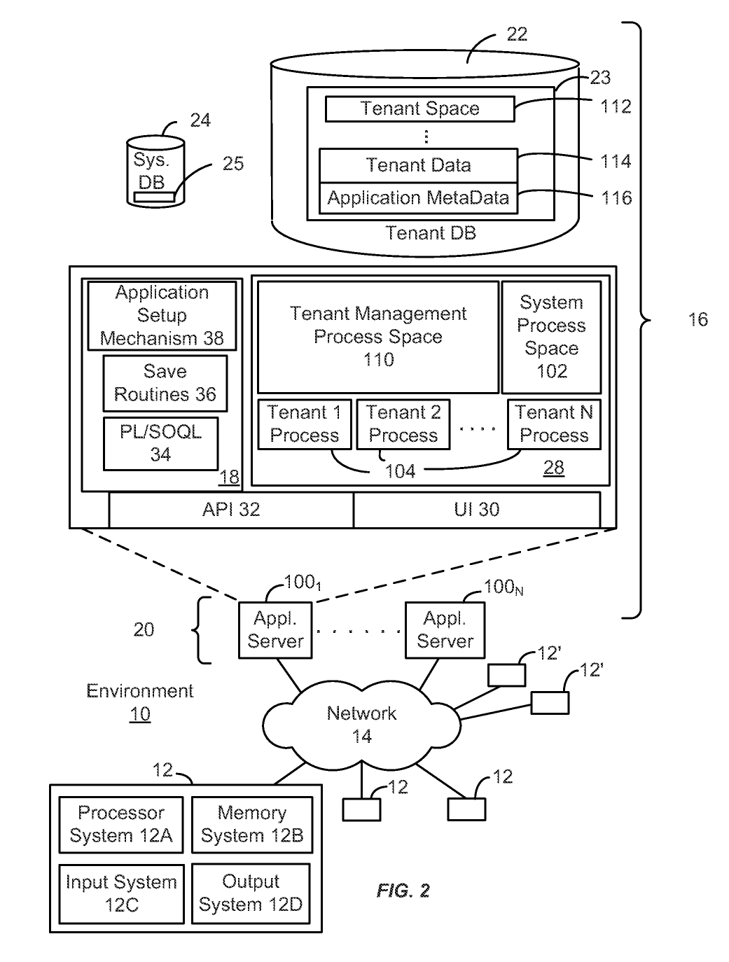

Environment 10 may include an on-demand database service. User systems 12 may be any machine or system that is used by a user to access a database user system. For example, any of user systems 12 can be a handheld computing device, a mobile phone, a laptop computer, a workstation, and/or a network of computing devices. As illustrated in FIG. 1 (and in more detail in FIG. 2) user systems 12 might interact via a network 14 with an on-demand database service system 16.

An on-demand database service, such as system 16, is a pre-established database system that is made available to outside users that do not necessarily need to be concerned with building and/or maintaining the database system, but instead may be available for their use when the users need the database system (e.g., on the demand of the users). In some on-demand database services, information from one or more tenants may be stored into tables of a common database image to form a multi-tenant database system (MTS). Accordingly, “on-demand database service 16” and “system 16” are used interchangeably herein. A database image may include one or more database objects. A relational database management system (RDMS) or the equivalent may execute operations for storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creating, managing and executing one or more applications developed by the provider of the on-demand database service, and enables users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system 12 has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited.

User systems 12 might communicate with system 16 using TCP/IP and, at a higher network level, communicate using other common Internet protocols such as HTTP, FTP, AFS, WAP, etc. In an example where HTTP is used, a user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications as well as provide related data, code, forms, webpages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that tenants do not have access to each other's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23 (FIG. 2), system data storage 24 for system data 25 (FIG. 2) accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide webpages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, FIG. 2 further illustrates elements of system 16 and various interconnections in an embodiment. FIG. 2 shows a user system 12 may include processor system 12A, memory system 12B, input system 12C, and output system 12D. Additionally, FIG. 2 also includes systems 12′. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, and tenant management process space 110. Tenant data 23 includes tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above with reference to FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. Systems 12′ may be any in-house machines or systems in relation to the on-demand database service, that may be used by a user to access a database user system or for any other purpose, such as software application development and testing. An in-house machine or system may be physically located on-site and/or otherwise associated with the on-demand database service. As illustrated in FIG. 2, systems 12′ might interact via a network 14 with an on-demand database service, which is system 16. In an embodiment, systems 12′ may interact directly with an on-demand database service without benefit of network 14. System 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12 and 12′. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12 and 12′. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by a tenant management process space 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber, making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, handling storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. “Table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. The word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

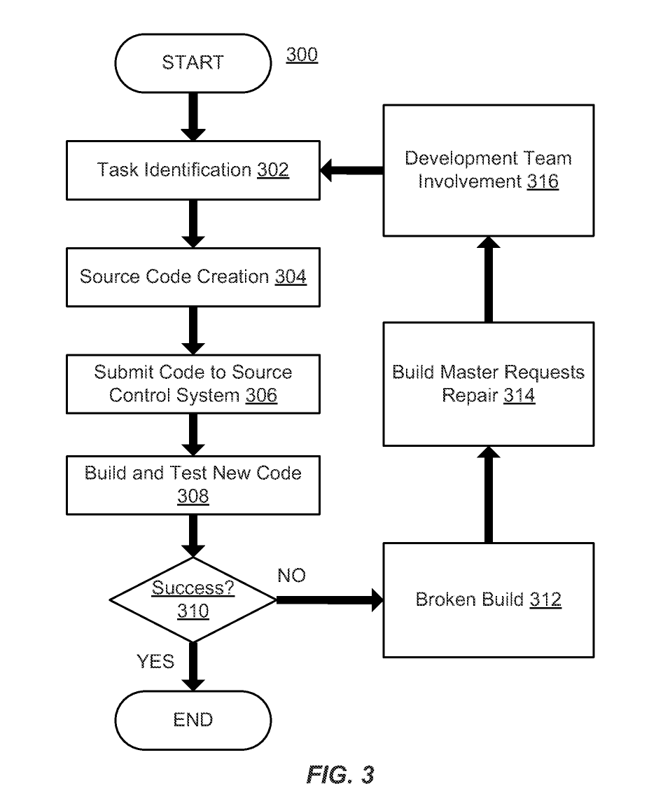

FIG. 3 shows a flowchart of an example software development cycle 300. The example software development cycle 300 may contain task identification 302, source code creation 304, code submission 306, build and test code 308, pass/fail 310, broken build 312, request to repair 314, and developer involvement 316. In other embodiments, an example software development cycle 300 may not have all of the components listed and/or may have other elements instead of, or in addition to, those listed above.

In task identification 302, developers may identify tasks that need to be completed for a piece of software. For example, developers may identify bugs in previous software releases needing repair or new features users would like to see added to the next software release. A bug may be any software error or flaw resulting in an unexpected output or behavior. After identifying tasks that need to be completed, in step 304, developers create source code.

The creation of source code 304 may include developers modifying existing source code and/or writing new source code to complete identified tasks. The creation of source code 304 may also include locally compiling and testing the new source code. For example, the developer may use his or her own workstation to convert, or compile, the human-readable source code into machine-readable binary code or object code. The developer may then test the new code to determine whether the code functions as expected. In an embodiment, testing of the source code may include functional testing. In an alternative embodiment, testing may include unit testing of the source code. Functional testing, or ftests, may ensure that the system functions as expected by a user. Unit testing may ensure that a particular method produces the expected output based on a known input.

In step 306, the new source code may be submitted, or checked-in, to a source control system. Newly created source code may be contained and/or submitted as a list of files, or a changelist. In this specification, “new source code”, “changed source code”, and “changelist” may be used interchangeably to refer to source code created to repair bugs or add features. A source control system may be any hardware system or network of hardware systems configured to run an application for managing source code files. For example, Perforce™, Synergy™, ClearCase™, StarTeam™, etc., are applications that may be used for managing source code. The source control system may have a server or multiple servers which contain a repository of versioned source code files used for creating software programs. The source control system may also contain a database of metadata about the source code files contained in the repository. For example, the database of metadata may include information such as file state, file attributes, merging and branching data related to the files, file version information, and user privileges, among other things. The source control system may also handle the submission, deletion, access, and transfer, of source code files contained in the repository. In this specification the terms “submit”, “submission”, “check-in”, and “commit”, may be used interchangeably to represent the integrating and/or merging of new source code to versioned source code.

In an embodiment, the source control system may be part of an automated build environment which is responsible for executing automated processes for building and testing new source code. An automated build environment may use a software tool to simplify source code compilation and testing procedures by automating the compilation and testing process. For example, an automated build environment may employ Ant, Make, Nant, or other build automation software, to automate the procedures for building and testing source code. While the process of compiling source code converts human-readable source code into machine-readable code, a build encompasses compiling the source code as well as other tasks which may include checking out source code, linking compiled source code with libraries, the generation of reports, etc.

In step 308, the newly checked-in source code may be automatically built and tested via the automated build environment. While the source code may have compiled and tested properly on the local developer workstation, the new source code may be built and tested via the automated build environment to ensure errors did not occur during check-in. Building and testing the new source code after check-in may also serve to verify that the new code is compatible with new changes submitted by other developers.

In an embodiment, the automated testing may employ ftests created and specified by the developer. The ftests may be divided into separate testing suites, allowing developers to choose between different levels of validation. For example, developers may choose to use a basic ftest suite, which may test code less thoroughly but quickly return testing results to developers. Alternatively, developers may choose to use an extended ftest suite, which may thoroughly test code but take longer to complete testing than a basic ftest suite. In an alternative embodiment, the automated testing may include unit tests of the of the new source code.

In step 310, developers determine whether the new source code properly compiled and passed specified tests. Developers may receive a report generated by the automated build environment indicating the success or failure of the compilation and testing. In the event the newly built program, or build, compiles properly and functions as expected, the bug repair and new feature addition may be considered successful. However, the build may fail to properly compile or the build may fail testing, and in step 312, results in a broken build.

A broken build may require a build master to take steps necessary to repair the broken build. For example, a build master may notify the developer responsible for breaking the build to repair the build or he may repair the build himself. A build master may be any individual responsible for maintaining builds, verifying that the source control system and automated build environment are functioning correctly, and/or requesting repairs for broken builds. In step 314, the build master may request the developer or developers responsible for breaking the build to repair the build. In step 316, in response to the build master request, the developer or developers responsible for breaking the build may attempt to repair the build. The diversion of development resources to repairing a broken build instead of completing other development tasks may delay the progress of the software development process.

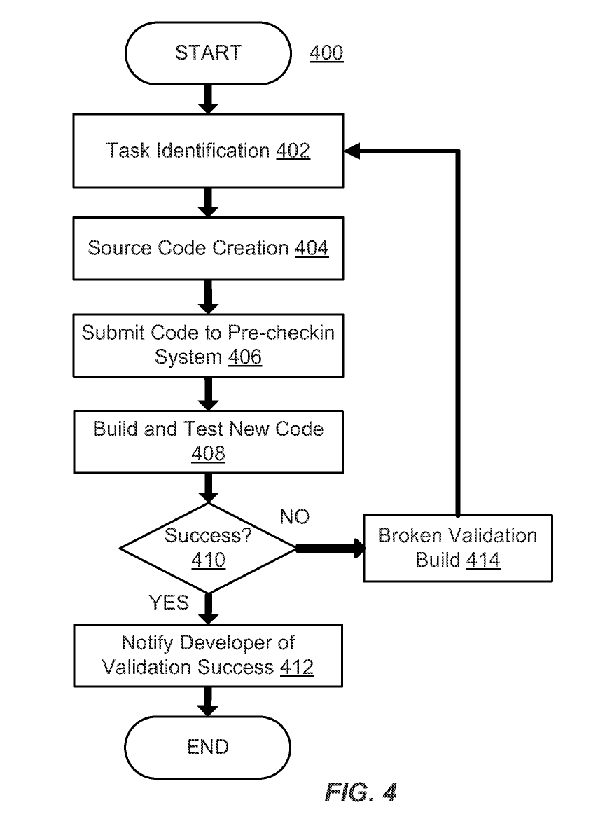

FIG. 4 shows a flowchart of a software development cycle 400 incorporating source code validation before submission to a source control system. A software development cycle 400 incorporating source code validation before submission to a source control system may include task identification 402, source code creation 404, submission to validation pre-checkin system 406, build and test code 408, pass/fail 410, validation notification 412, and broken validation 414. In other embodiments, a software development cycle 400 incorporating source code validation before submission to a source control system may not have all of the components listed and/or may have other elements instead of, or in addition to, those listed above.

Task identification 402 may be similar or identical to the task identification 302 used in a typical software development cycle 300 described previously. Source code creation 404 may also be similar or identical to the source code creation 302 used in a typical software development cycle 300 described previously. After identifying tasks and creating source code addressing the tasks, in step 406, the new source code is submitted to a pre-check-in source code validation system. In an embodiment, a pre-check-in source code validation system may incorporate an automated build environment. In another embodiment, a source code validation system may incorporate a portion of an automated build environment.

In step 408, a pre-check-in source code validation system automatically builds and tests the new source code. By using the same or similar automated build environment components to validate the new source code before submission as will be used after submission, build breakages after submission may be minimized or eliminated altogether. Step 410 determines whether the new source code was successfully built and tested. If the new source code properly compiles and passes tests designated by the developer, in step 412, the pre-check-in source code validation system may notify the responsible developer of the successful compilation and passing of designated tests. Optionally, the developer may elect to have the successfully built and tested source code automatically checked-in to a source control system based on the developer credentials. If the new source code does not compile correctly or does not pass specified testing, in step 414, the pre-check-in validation build is declared broken. A broken pre-check-in validation build returns the developer to step 402 of the development process to identify and repair the bugs and errors resulting in the broken pre-check-in validation build.

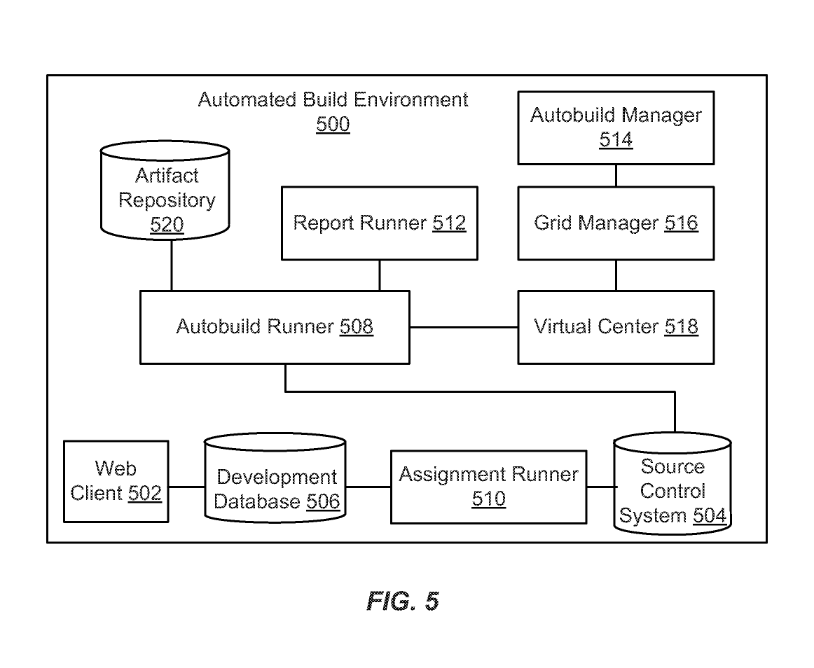

FIG. 5 illustrates a block diagram of an example automated build infrastructure 500 which may include web client 502, source control system 504, development database system 506, autobuild runner 508, assignment runner 510, report runner 512, automated build manager 514, grid manager 516, virtual center 518, and artifact repository 520. In other embodiments, an automated build infrastructure 500 may not have all of the components listed, may have combined components, and/or may have other elements instead of, or in addition to, those listed above.

Web client 502 may be a front-end, or user interface, for the automated build environment 500. In an embodiment, the web client 502 may allow a developer to remotely access and interact with the automated build environment 500. For example, the web client 502 may be a webpage or other network accessible interface that allows users to monitor, maintain, and/or set up the automated build environment 500 for compiling and testing source code. In an embodiment, the web client 502 may be used to upload source code changes and/or changelists to a source control system of the automated build environment 500. The source control system 504, as described previously, may be any system or network of systems configured to manage versioned source code files. The source control system 504 may have both a database for storing system related metadata and a repository, or depot, for storing versioned file content.

The development database system 506 may be a database containing data about builds, test executions, test results, and test configuration data, among other things. In an embodiment, the development database system 506 may contain runtime data, including a queue which may be monitored by the autobuild runner 508. A queue may be an inventory of various tasks waiting to be processed. For example, the queue may include regularly scheduled builds waiting to be compiled and tested or newly added builds containing new source code changes. A runner may be a combination of instructions, scripts, and/or applications for automating tasks or causing tasks to be performed. For example, an autobuild runner 508 may automate the various tasks required to build and test the latest version of source code scheduled in the queue of the development database system 506. The various tasks handled by the autobuild runner 508 may include compiling the source code, linking the objects created by the compilation, running tests, etc. In an embodiment, the autobuild runner 508 may be responsible for periodically checking, or polling, the queue of the development database system 506 for changes made to the source control system 504 and running the builds, i.e., automatically compiling source code and testing the resulting compilation. In an embodiment, the remote testing functionality may be implemented in a tools.autobuild.StartRemoteTest class on the development database system 506, which is a class having tools for automatically compiling source code and starting a remote test. In an alternative embodiment, the remote testing functionality may be implemented in another class. In an embodiment, the autobuild runner 508 may utilize other automated build infrastructure components to automatically compile and test new source code.

Assignment runner 510 may be responsible for automatically monitoring changes made to the source control system 504. For example, users may upload any source code changes to the source control system 504, which may then be identified by the assignment runner 510. Based on the uploaded source code changes, the assignment runner 510 may then automatically place runs for those changes into the queue on the development database 506. The autobuild runner 508 then picks up the runs from the queue on the development database 506 and compiles and tests the source code based on the changes. The report runner 512 may be used for automatically returning the results of the compilation and testing. In an embodiment, the report runner 512 may automatically generate reports based on compilation and testing results and notify the submitting developer.

The automated build manager 514 may be an application for managing the build process. As the build process may occur on multiple machines, the automated build manager 514 may simplify the task of managing the build process by allowing the developer to monitor the progress of the build process as it occurs. The grid manager 516 may be an application for provisioning systems for compiling and running builds. As the resources required for building a complex application may be large, it may be more practical and efficient to divide the task of running a build amongst multiple systems. Depending on the resources required of the build, the number of systems provisioned by the grid manager 516 may range from just a few systems to thousands of systems. The virtual center 518 may be the actual test instance on the grid of machines provisioned by the grid manager 516. The artifact repository 520 may be a repository for artifacts that result from the builds. The artifacts may be compiled versions of the source code.

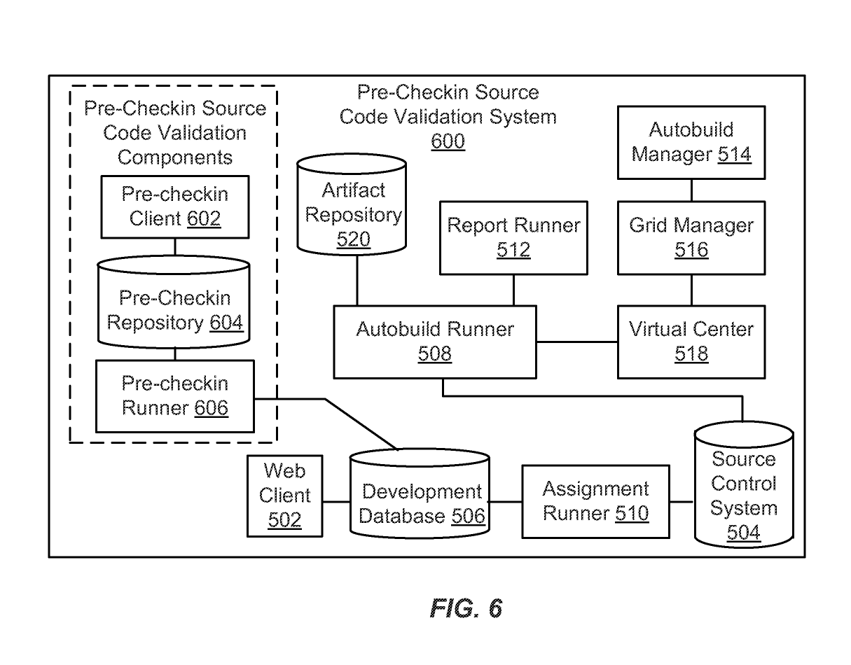

FIG. 6 illustrates a block diagram of an example pre-check-in source code validation system 600 incorporating an automated build environment 500 with the addition of pre-check-in client 602, pre-check-in repository 604, and pre-checkin file assignment runner 606. In other embodiments, the pre-check-in source code validation system 600 may not have all of the components listed and/or may have other elements instead of, or in addition to, those listed above.

The pre-check-in client 602 may be a front-end for the pre-check-in source code validation system 600. In an embodiment, developers may use pre-check-in client 602 to remotely upload changelists to the pre-check-in source code validation system 600. For example, in an embodiment where a pre-check-in source code validation system 600 employs a Perforce source control system and Ant software build tool, to submit a changelist, a developer may first access a user interface allowing the developer to change directories to a directory containing software for handling the submission of the changelist e.g., cd <p4-client-ws>\main\core\build, where <p4-client-ws> refers to the source control system client workspace, and \main\core\build refers to the directory where the software may be found. The developer may then submit a pending changelist to a remote functional test server via the pre-check-in client 602 by invoking: -Dchange=<pending changelist number>, where the pending changelist number may be a pending changelist in the working release. In an embodiment, the pre-check-in client 602 may also be used to upload and start functional tests. Remote tests may be started by the developer by invoking: ant-Dchange=<pending change number> remote.XXX, where the XXX parameter may be substituted with remote.basicftest, remote.ftest, or remote.extendedftest targets, depending on the desired level of validation. If the developer wishes to simply submit and build a changelist, the developer may invoke the command: ant-Dchange=<pending change number> remote.build. If the developer wishes to submit the changelist and run a basic ftest suite, the developer may invoke the command: ant-Dchange=<pending change number> remote.basicftest. If the developer wishes to submit the changelist and run a standard ftest suite, the developer may invoke the command: ant-Dchange=<pending change number> remote.ftest. A changelist having a pending change number 605677 that a developer wishes to be subject to a basic ftest suite, may be invoked by the developer as: ant-Dchange=605677 remote.basicftest.

Developers may invoke-DsyncTo=<change number> to optionally specify which change number test machines synchronize with before applying a changelist. The synchronization may ensure the latest changes and files are used. The default value may be head of the line, the head of the line being the latest version of files. If there are conflicts within a pending changelist, and the pending change list was created right after synchronizing, specifying the pending changelist number again may resolve the conflicts. In an embodiment, the remote test functionality may create a zip file including all the add/edit files and an xml file describing which files are to be added/edited/deleted. The zip file may be uploaded to an apache web server (pre-check-in web file server).

Changelists uploaded by the pre-check-in client 602 may be stored in the pre-check-in repository 604. The pre-check-in repository 604 may be a database for storing source code changes. The file assignment runner 606 may be similar to the assignment runner 510 of the automated build environment 500. The file assignment runner 606 monitors the pre-check-in repository 604 for uploaded source code changes and/or changelists. When source code changes and/or changelists are identified, the file assignment runner may add runs reflecting the new code changes into the queue stored on the development database 506, where it may be picked up by the autobuild runner 508 of the automated build environment 500 and compiled and tested accordingly. For example, in an embodiment, the file assignment runner 606 daemon may poll a file server (pre-check-in repository) and insert rows into the runs table stored on the development database 506 for pre-check-in runs. In an embodiment, there may be a PRECHECKIN run type and an added conditional check before executing runs for the PRECHECKIN run type. For example, if the run type is the PRECHECKIN run type, then the pre-check-in preparation process may be executed before an automated build run starts. In an embodiment, the preparation process may include downloading a zip file from a pre-check-in web file server (the server being the server to which the client may submit the pre-check-in changelist), unzipping the changelist file set to proper relative directories, unmarshalling the xml file, and issuing commands based on xml content (adding, deleting, editing files). In an embodiment, the configuration parameters may include remote.fs.url, which may be the URL of the server hosting the zipped source files. In an embodiment, unzip.temp.dir may be the temporary directory path where the zip files may be downloaded and unzipped. In an embodiment, a PRECHECKIN run type may also have a post process after the automated build finishes. For example, after the automated build run finishes, the post process may include reverting any commands resulting in changes made to the source control system and cleanup of unzipped changelist files. In an embodiment, no arguments may be required, but configuration parameters may be set on the database under the section name “precheckin”

In an embodiment, polling the pre-check-in repository file server and inserting rows into the runs table stored on the development database 506 for pre-check-in runs may be run as a singleton. Being run as a singleton may prevent the insertion of duplicate pre-check-in runs.

The report runner of the automated build environment 500 may return a report to the developer indicating the success or failure of the compilation and testing. In an embodiment, if the pre-check-in validation is successful, i.e. the new source code is successfully compiled and tested, the new source code may be automatically submitted from autobuild servers to the source control system 504 using the developer's credentials. In an embodiment, before autosubmission, for a pre-check-in autobuild, the test server may startup as well. In the event the changes fail to successfully compile or fail testing, the developer will be notified and may repair the code. In an embodiment, the build fails if there is a more recent version of any file in the changelist or if the metadata is inconsistent, for example, instructions to delete a file that does not exist. In an embodiment, compilation and/or test failures may be stored and available in the development database 506 after the report runner has processed the results file and/or code and not during the autobuild run. In an embodiment, the code should be deleted and forced synced after every run because the code in the precheckin autobuild may never get checked in, the precheckin code can leave the file state in an irreconcilable state for the next run.

In an embodiment, deployment of the pre-checkin source code validation system 600 may be on a main or pilot mode. A pilot mode may allow software developers to optionally use the pre-checkin source code validation system. Alternatively, pilot mode may allow a limited number of developers to use the pre-checkin source code validation system 600. If deployed on main mode, all developers using the automated build environment 500 may be required to use the pre-checkin validation system 600 before submitting new source code to the source control system 504. In an embodiment, a pre-checkin autobuild may be able to determine if a failure also occurred in the last autobuild on main mode.

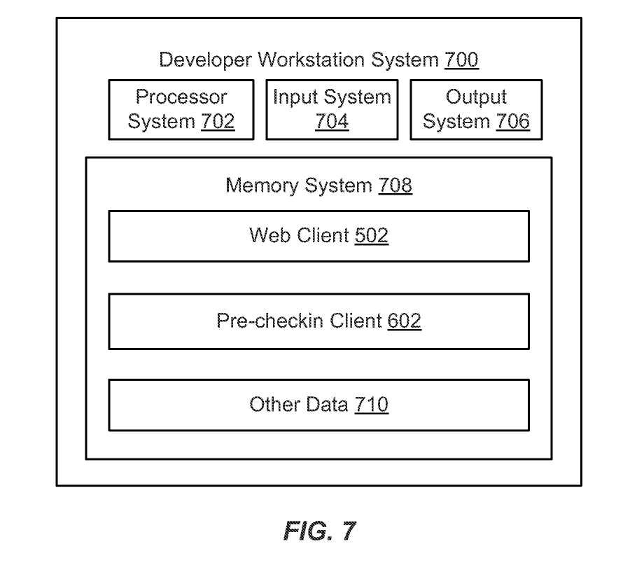

FIG. 7 shows a block diagram of an embodiment of a developer workstation system 700 with automated build environment components and pre-check-in validation components. In an embodiment, developer workstation system 700 may include processor system 702, input system 704, output system 706, and memory system 708. The memory system 708 may include web client 502 and pre-check-in client 602. The memory system 708 may further include other data 710. In other embodiments, a developer workstation system 700 may not have all of the components listed and/or may have other elements instead of, or in addition to, those listed above.

The developer workstation system 700 may be a computer system that allows developers to perform software development functions. For example, the developer workstation system 700 may allow a developer to write source code, compile source code, and test source code. In an embodiment, the developer workstation system 700 may also allow developers to perform any functions that can be performed on an ordinary computer system. For example, developer workstation system 700 may allow a developer to perform word processing, spreadsheet editing, etc. In an embodiment, the processor system 702 may be any combination of one or more processors. In an embodiment, the input system 704 may be any combination of input devices, such as one or more keyboards, mice, trackballs, scanners, cameras, and/or interfaces to networks. In an embodiment, the output system 706 may be any combination of output devices, such as one or more monitors, printers, and/or interfaces to networks. The memory system 708 may be any combination of one or more memory devices, short term and/or long term memory.

As described previously, the web client 502 may be a front-end for the automated build environment 500, and may allow a developer to use his or her developer workstation system 700 to interact with the automated build environment 500. For example, web client 502 may allow a developer to submit a changelist or ftests. The pre-check-in client 602 may be a front-end for the pre-check-in source code validation system 600, and may allow a developer to use his or her developer workstation 700 to interact with the pre-check-in source code validation system 600.

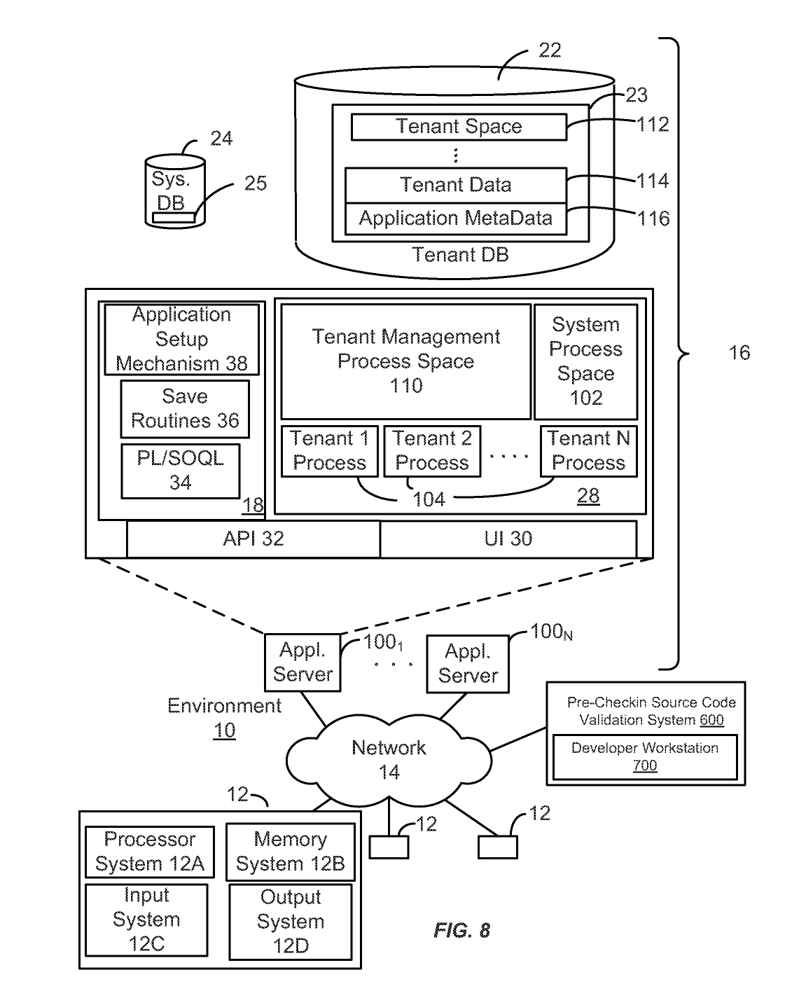

FIG. 8 illustrates a block diagram of an example of an environment 10 wherein a pre-check-in source code validation system 600 might be used along with an on-demand database service. The pre-check-in source code validation system 600 may exist on multiple machines or hardware systems connected to environment 10 via network 14. The hardware systems where the pre-check-in source code validation system 600 resides may be any in-house machine or system in relation to the on-demand database service. An in-house machine or system may be physically located on-site and/or otherwise associated with the on-demand database service.

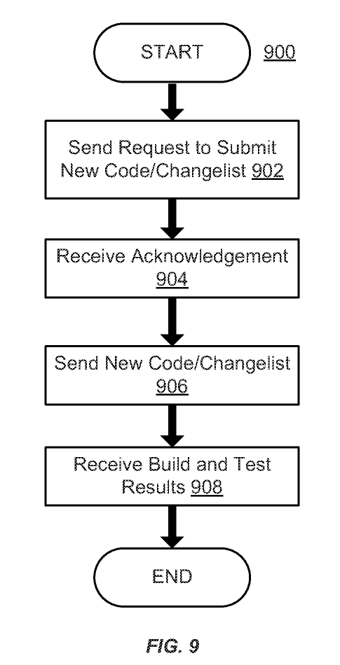

FIG. 9 shows an embodiment of a user side method 900 for source code validation before submission to a source control system. A user side method 900 may include send request 902, receive acknowledgement 904, send changelist 906, and receive results 908. In other embodiments, the user side method 900 may not have all of the components listed and/or may have other elements instead of, or in addition to, those listed above.

In step 902, a developer may use a developer workstation system 700 to send a request to pre-check-in source code validation system 600. After sending the request the developer workstation system may, in step 904, receive acknowledgement of receiving the request by the pre-check-in source validation system 600. In step 906, the developer may send new source code changes and functional tests to the pre-check-in source code validation system 600. The new source code may be sent as a changelist, or as a set of files containing the changes. In an embodiment, the files may be zipped or compressed before being uploaded to the pre-check-in source code validation system 600. In step 908, the developer may receive at the developer workstation system 700 the results of the automated build and test resulting from the uploaded changelist.

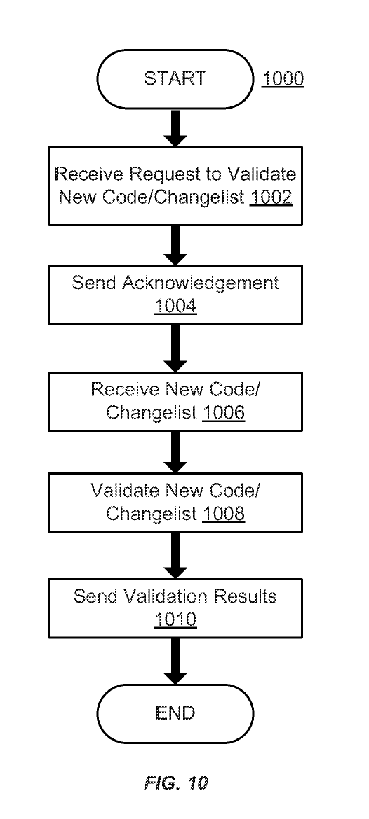

FIG. 10 shows an embodiment of a system side method 1000 for source code validation before submission to a source control system. A system side method 1000 may include receive request 1002, send acknowledgement 1004, receive changelist 1006, validate changelist 1008, and send results 1010. Other embodiments of a system side method 1000 may not have all of the components listed and/or may have other elements instead of, or in addition to, those listed above.

In step 1002, pre-check-in source code validation system 600 may receive a request to submit source code changes from a developer workstation system 700. In response to the request to submit source code changes, the pre-check-in source code validation system 600 may, in step 1004, send an acknowledgement to the developer workstation system 700. In step 1006, the pre-check-in source code validation system 600 receives source code changes and functional tests from the developer workstation system 700. In an embodiment, the source code changes may be received in the form of a changelist, and the changelist may be received as a zipped or compressed file. In step 1008, the pre-check-in source code validation system 600 validates the new source code by building the new source code and running developer specified functional tests. Upon completion of the validation process, the pre-check-in source code validation system 600 sends the validation results to the developer workstation 700.

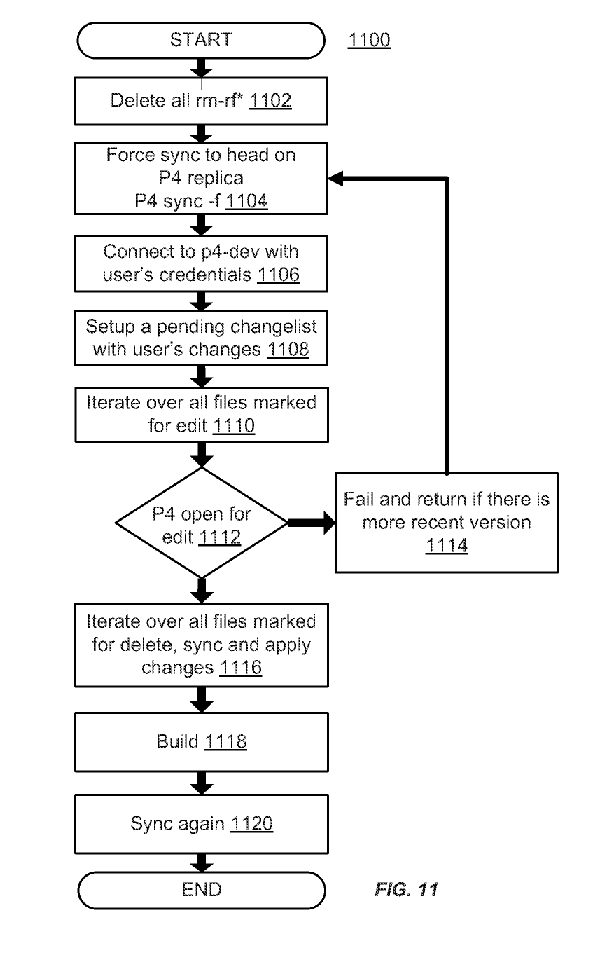

FIG. 11 shows an embodiment of a detailed system-side method 1100 for source code validation before submission to a source control system. A detailed system-side method 1100 for source code validation before submission to a source control system may include deletion 1102, force synchronization 1104, connect 1106, changelist setup 1108, first iteration 1110, open for edit 1112, fail and return 1114, second iteration 1116, build 1118, and synchronization 1120. In other embodiments, the detailed system-side method 1100 for source code validation before submission to a source control system may not have all of the components listed and/or may have other elements instead of, or in addition to, those listed above.

A detailed system-side method 1100 for source code validation before submission to a source control system may begin with deletion 1102. Deletion 1102 may delete any files previously stored on the workspace of a pre-checkin build server to have a clean workspace. Once the developer has uploaded a changelist to a file server, in force synchronization step 1104, the latest version of source code files are picked up by a replicated development server and the changelist is picked up by the pre-check-in build server. In step 1106, the pre-check-in build server logs itself into a replicated development server, using the developer's credentials. Once connected to the replica development server, in step 1108, a pending changelist may be uploaded to the replica development server from the pre-check-in build server. In step 1110, the replica development server iterates over all files that are marked for edit as indicated by the uploaded changelist. In step 1112, the replica development server files are opened for editing according to the changelist. In the event the files are no longer the most recent version, in step 1114, the editing is failed and the method is returned to force synchronization step 1104. If the files are the most recent version, in step 1116, the files are edited according to the changelist. In step 1118, a build is run according to the changes of the changelist. In step 1120, a synchronization is executed again to check for the latest file revisions.

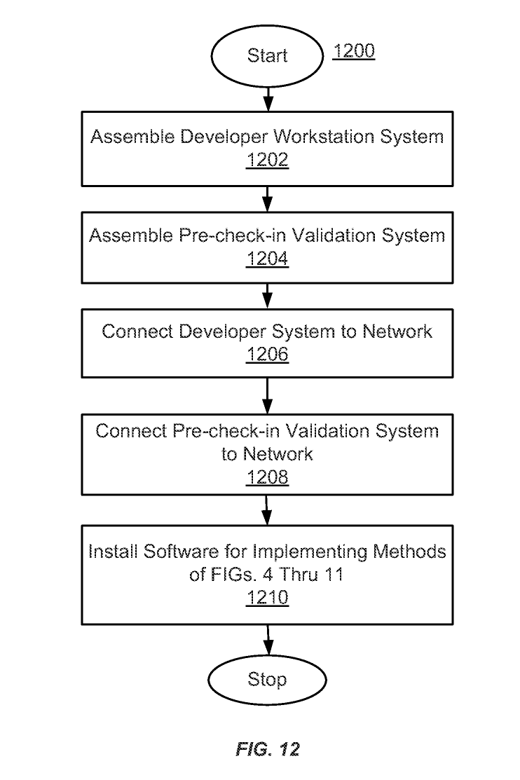

FIG. 12 is a method 1200 for making a pre-check-in source code validation system 600 having a developer workstation 700. A method for making a pre-check-in source code validation system 600 may include, workstation system assembly 1202, pre-check-in system assembly 1204, connect workstation system 1206, connect pre-check-in systems 1208, and install software 1210. In other embodiments, a method 1200 for making a pre-check-in source code validation system 600 having a developer workstation 700 may not have all of the steps listed and/or may have other steps instead of, or in addition to, those listed above.

In step 1202, developer workstation system 700 is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 1204, system 600 (FIG. 6 and FIG. 8) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 1206, developer workstation system 700 is communicatively coupled to network 104. In step 1208, source code validation system 600 is communicatively coupled to network 104 allowing developer workstation system 700 and system 600 to communicate with one another. In step 1210, one or more instructions may be installed in system 700 and 600 (e.g., the instructions may be installed on one or more machine readable media, such as computer readable media, therein) and/or system 700 and 600 are otherwise configured for performing the steps of methods associated with FIG. 4 thru FIG. 11. In an embodiment, each of the steps of method 1200 is a distinct step. In another embodiment, although depicted as distinct steps in FIG. 12, steps 1202-1210 may not be distinct steps. In other embodiments, method 1200 may not have all of the above steps and/or may have other steps in addition to, or instead of, those listed above. The steps of method 1200 may be performed in another order. Subsets of the steps listed above as part of method 1200 may be used to form their own method.

### Extensions and Alternatives

Each embodiment disclosed herein may be used or otherwise combined with any of the other embodiments disclosed. Any element of any embodiment may be used in any embodiment.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for validating source code changes prior to submission to a source control system, the method comprising the steps of:
receiving, at a server machine from a remote developer machine, at least one source code change for validation before submission to a source control system;
building, via a pre-check-in validation system associated with the server machine, an application that includes the at least one source code change for validation before submission to a source control system;
testing, via the pre-check-in validation system associated with the server machine, the application that includes the at least one source code change for validation prior to submission to a source control system; and
sending, notification of building and testing results of the at least one source code change, from the pre-check-in validation system to the developer machine.

2. The method of claim 1, further comprising:
automatically submitting the at least one source code change to a source control system of the pre-check-in validation system if the building and testing of the application that includes the at least one source code change is successful.

3. The method of claim 2, wherein automatically submitting the at least one source code change is based on developer credentials.

4. The method of claim 1, wherein the at least one source code change for validation before submission to a source control system is included in a changelist of source code changes.

5. The method of claim 1, wherein the step of testing uses functional tests to verify the application performs as expected.

6. The method of claim 1, wherein the step of testing uses tests organized into test suites.

7. The method of claim 1, wherein the step of testing uses functional tests organized into test suites.

8. The method of claim 1, wherein the pre-check-in validation system includes an automated build environment configured to automatically build and test source code before submission to a source control system.

9. The method of claim 1, wherein the developer machine remotely sends to a server machine associated with a pre-check-in validation system, functional tests for testing the application before submission to a source control system.

10. The method of claim 1, wherein the step of building is executed automatically by the pre-check-in validation system.

11. The method of claim 1, wherein the step of testing is executed automatically by the pre-check-in validation system.

12. The method of claim 1, wherein the steps of building and testing are executed automatically by the pre-check-in validation system.

13. The method of claim 1, further comprising:
automatically submitting the at least one source code change to a source control system of the pre-check-in validation system if the building and testing of the application that includes the at least one source code change is successful, wherein automatically submitting the at least one source code change is based on developer credentials, and wherein the pre-check-in validation system includes an automated build environment configured to automatically build and test source code before submission to a source control system,
the building and testing are executed automatically by the pre-check-in validation system, the at least one source code change for validation before submission to a source control system is included in a changelist of source code changes,
the testing uses functional tests organized into test suites, and
the developer machine remotely sends to a server machine associated with a pre-check-in validation system, functional tests for testing the application before submission to a source control system.

14. A computer-readable medium storing one or more sequences of instructions for causing one or more processors to implement a method for validating source code changes prior to submission to a source control system, the method comprising the steps of:
receiving, at a server machine from a remote developer machine, at least one source code change for validation before submission to a source control system;
building, via a pre-check-in validation system associated with the server machine, an application that includes the at least one source code change for validation before submission to a source control system;
testing, via the pre-check-in validation system, the application that includes the at least one source code change for validation before submission to a source control system; and
sending, notification of building and testing results of the at least one source code change from the pre-check-in validation system to the developer machine.

15. The computer readable medium of claim 14, the method further comprising:
automatically submitting the at least one source code change to a source control system of the pre-check-in validation system if the building and testing of the application that includes the at least one source code change is successful.

16. The computer readable medium of claim 14, further comprising:
automatically submitting the at least one source code change to a source control system of the pre-check-in validation system if the building and testing of the application that includes the at least one source code change is successful, wherein the automatically submitting of the at least one source code change is based on developer credentials, and wherein the pre-check-in validation system includes an automated build environment configured to automatically build and test source code before submission to a source control system,
the building and testing are executed automatically by the pre-check-in validation system,
the at least one source code change for validation before submission to a source control system is included in a changelist of source code changes,
the testing uses functional tests organized into test suites, and
the developer machine remotely sends to a server machine associated with a pre-check-in validation system, functional tests for testing the application before submission to a source control system.

17. A validation system for validating source code changes prior to submission to a source control system, the validation system comprising:
a processor system;
volatile memory; and
non-volatile memory including at least one machine readable medium carrying one or more sequences of instructions causing the processor system to implement a method comprising the steps of:
receiving, at a server machine from a remote developer machine, at least one source code change for validation before submission to a source control system;
building, via a pre-check-in validation system associated with the server machine, an application that includes the at least one source code change for validation before submission to a source control system;
testing, via the pre-check-in validation system, the application that includes the at least one source code change for validation before submission to a source control system; and
sending, notification of building and testing results of the at least one source code change from the pre-check-in validation system to the developer machine.

18. The system of claim 17 which, if the building and testing of the application of the at least one source code changes is successful, automatically submits the at least one source code change to a source control system of the pre-check-in validation system.

19. The system of claim 17, further comprising:
automatically submitting the at least one source code change to a source control system of the pre-check-in validation system if the building and testing of the application that includes the at least one source code change is successful, wherein the automatically submitting of the at least one source code change is based on developer credentials, wherein the pre-check-in validation system includes an automated build environment configured to automatically build and test source code before submission to a source control system,
the building and testing are executed automatically by the pre-check-in validation system,
the at least one source code change for validation before submission to a source control system is included in a changelist of source code changes,
the testing uses functional tests organized into test suites, and
the developer machine remotely sends to a server machine associated with a pre-check-in validation system, functional tests for testing the application before submission to a source control system.
